(19) United States
(12) Patent Application Publication
(10) Pub. No.: US 2020/0271018 A1
(43) Pub. Date: Aug. 27, 2020

(54) SYSTEM AND METHOD FOR MANAGING POWER TO AN ENGINE CONTROLLER

(71) Applicant: PRATT & WHITNEY CANADA CORP., Longueuil (CA)

(72) Inventor: Sean MCCARTHY, Beaconsfield (CA)

(21) Appl. No.: 16/281,706

(22) Filed: Feb. 21, 2019

(51) Int. Cl. F01D 25/36; F01D 21/14; F01D 21/20

(52) U.S. Cl. CPC F01D 25/36; F01D 21/14; F05D 2220/323; F05D 2260/40; F05D 2260/57; F01D 21/20

(57) ABSTRACT

A method and system for managing power to an engine controller operatively coupled to an engine of an aircraft are described. The method comprises powering the engine controller from an aircraft battery, starting a timer in response to a predetermined trigger to maintain the engine controller powered by the aircraft battery for a predetermined time, and removing power from the aircraft battery to the engine controller when the timer expires.

### TECHNICAL FIELD

The present disclosure relates generally to gas turbine engines, and more particularly to power management for engine controllers.

### BACKGROUND OF THE ART

An engine controller is used to control most gas turbine engines. To operate, a source of power must be provided to the engine controller. When the engine is operating normally, the engine controller can be powered from a permanent magnet alternator in the engine. When the engine is off or running at very low speeds, the aircraft battery is the primary source of power for the engine controller.

After a flight and upon engine shutdown, pilots are required to adhere to specific operating procedures in order to maintain power to the engine controller long enough for it to complete post engine shutdown functions.

Therefore, improvements are needed.

### SUMMARY

In accordance with a broad aspect, there is provided a method for managing power to an engine controller operatively coupled to an engine of an aircraft. The method comprises powering the engine controller from an aircraft battery, starting a timer in response to a predetermined trigger to maintain the engine controller powered by the aircraft battery for a predetermined time, and removing power from the aircraft battery to the engine controller when the timer expires.

In accordance with another broad aspect, there is provided a system for managing power to an engine controller operatively coupled to an engine of an aircraft. The system comprises an engine controller, an aircraft battery coupled to the engine controller via an electrical path, a power switch in the electrical path, a power coil adjacent to the power switch for actuating the power switch to close the electrical path and allow power to flow from the aircraft battery to the engine controller, and a timer responsive to a predetermined trigger to maintain the power coil energized for a predetermined time.

Features of the systems, devices, and methods described herein may be used in various combinations, in accordance with the embodiments described herein.

### BRIEF DESCRIPTION OF THE DRAWINGS

Reference is now made to the accompanying figures in which:

FIG. 1 is a schematic cross-sectional view of an example gas turbine engine;

FIG. 2 is a flowchart of an example method for managing power to an engine controller;

FIG. 3A is a block diagram of an example system for managing power to an engine controller;

FIG. 3B is a block diagram of another example system for managing power to an engine controller; and

FIG. 4 is a block diagram of an example computing device.

It will be noted that throughout the appended drawings, like features are identified by like reference numerals.

### DETAILED DESCRIPTION

There are described herein methods and system for managing power to an engine controller. In particular, power may be maintained autonomously and automatically to the engine controller upon engine shutdown and/or upon aircraft shutdown. This allows the engine controller sufficient time to perform any necessary post-engine shutdown functions without a power interruption. Examples of post-engine shutdown functions include recording engine oil levels with time delay, and downloading engine data from the engine controller to a data recorder, locally or remotely from the aircraft.

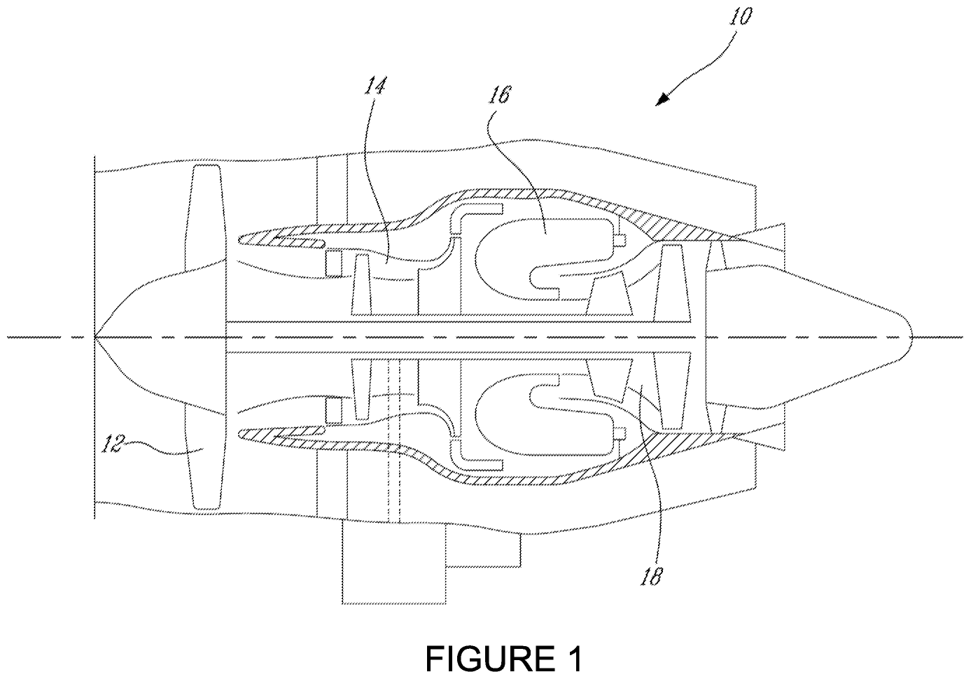

The engine controller is operatively coupled to an engine of an aircraft. FIG. 1 illustrates an example gas turbine engine 10 of a type preferably provided for use in subsonic flight, generally comprising in serial flow communication, a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

Although illustrated as a turbofan engine, the gas turbine engine 10 may alternatively be another type of engine, for example a turboshaft engine, also generally comprising in serial flow communication a compressor section, a combustor, and a turbine section, and a fan through which ambient air is propelled. A turboprop engine may also apply.

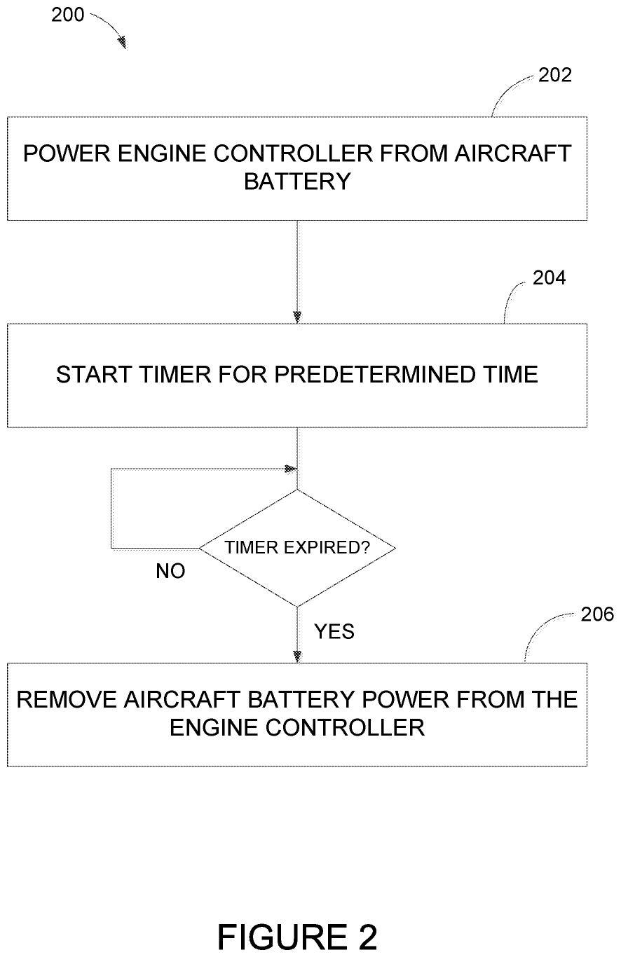

Turning to FIG. 2, there is illustrated a method 200 for managing power to an engine controller. At step 202, the engine controller is powered from an aircraft battery. In some embodiments, the aircraft battery is the primary source of power of the engine controller, i.e. the aircraft battery powers the engine controller throughout the flight. In some embodiments, the aircraft battery is the secondary source of power for the engine controller. For example, the aircraft battery powers the engine controller when the primary source of power is unavailable, or in specific circumstances, such as during certain segments of a mission or when the aircraft is on the ground. In some embodiments, the engine controller is powered from the aircraft battery in response to one or more events, such as the aircraft landing, a high power demand from the engine, and the like.

At step 204, a timer is started to maintain the engine controller powered by the aircraft battery for a predetermined time, in response to a predetermined trigger. In some embodiments, the predetermined trigger is an aircraft shutdown request or an engine shutdown request. The aircraft shutdown request and/or engine shutdown request may be pilot-initiated, for example through an input on a cockpit interface of the aircraft. A simple switch or button may be used in either case. Other triggers may also be used, such as but not limited to an aircraft door opening, a weight-on-wheels signal, the aircraft being below a certain altitude, a wheel speed falling below a certain threshold, and the like. The exact length of time of the timer can be configured on a per-application basis.

In some embodiments, the timer is started upon receipt of a request to shut down the aircraft, as received from the cockpit of the aircraft. The timer is thus used to delay the actual shutdown of the aircraft, until the time has elapsed, thus allowing post engine shutdown functions to be completed. In some embodiments, the timer is triggered upon receipt of a request to shut down the engine, as received from the cockpit of the aircraft. A pilot-initiated engine shut down is usually indicative of a forthcoming aircraft shutdown request. The timer may be started before the aircraft shutdown request is received and the engine controller is powered by the aircraft battery until the timer has expired. If an aircraft shutdown request is received before expiry of the timer, shutdown of the aircraft battery is delayed until the timer expires. At step 206, the aircraft battery power is removed from the engine controller when the timer expires.

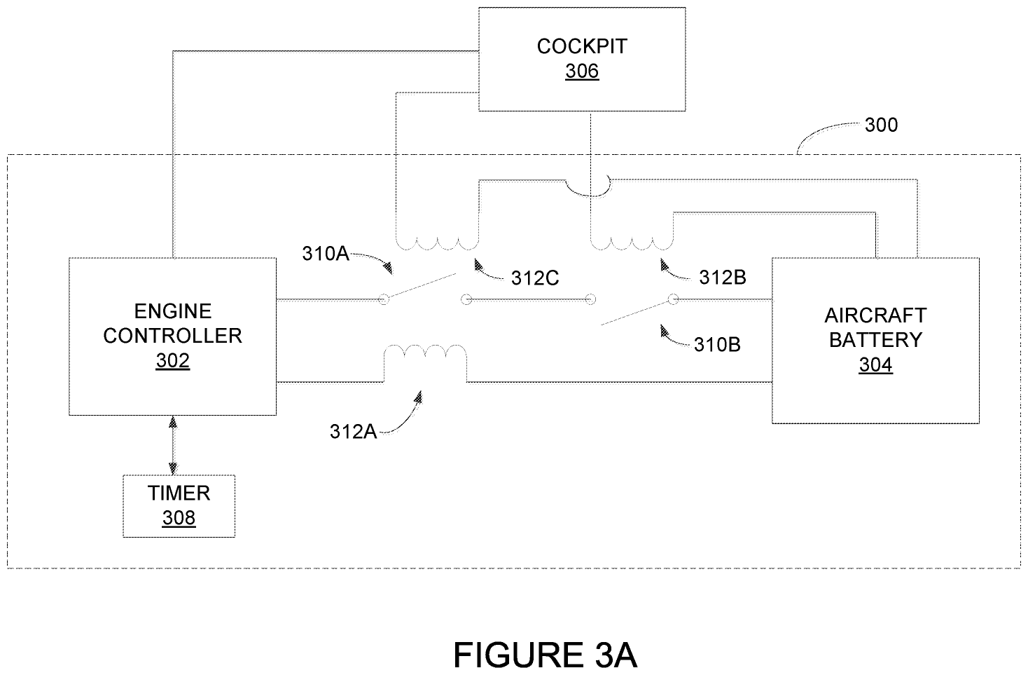

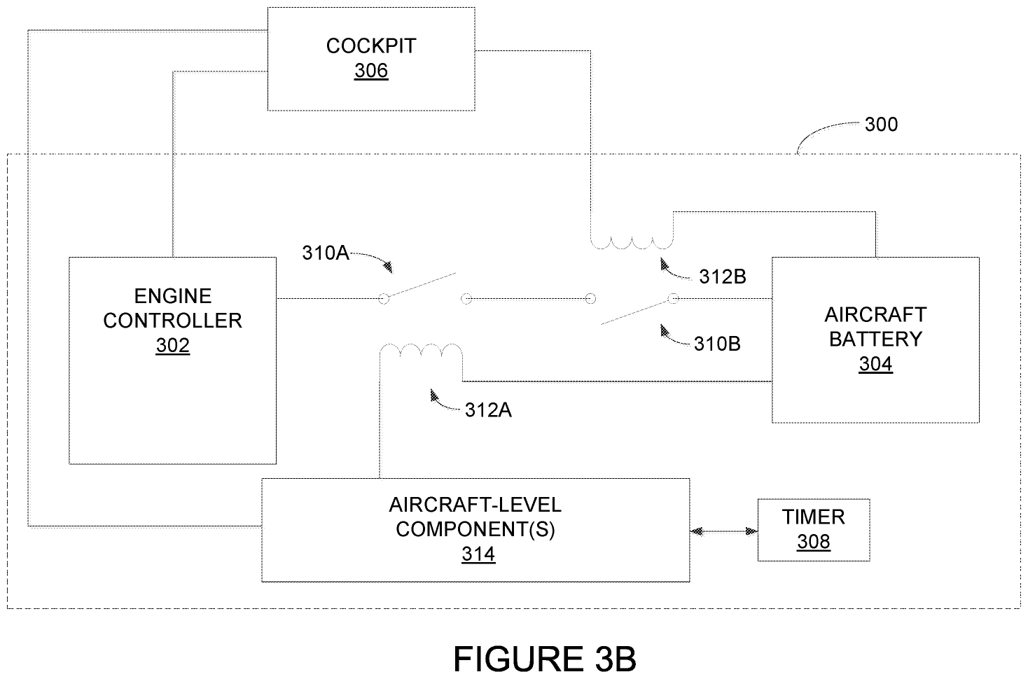

FIG. 3A illustrates an example embodiment of a system 300 for managing power to an engine controller 302. An aircraft battery 304 is coupled to the engine controller 302 via an electrical path. A power switch 310A is provided in the electrical path. A power coil 312A is adjacent to the power switch 310A. Energizing the power coil 312A generates a magnetic field in the power coil 312A, which actuates the power switch 310A to a closed position, thus closing the electrical path between the aircraft battery 304 and the engine controller 302 and powering the engine controller 302. The power coil 312A is energized by the engine controller 302. The engine controller 302 may energize the power coil 312A at any time, such as but not limited to in response to an aircraft-on-ground confirmation, in response to an aircraft shutdown request, and in response to an engine shutdown request. The engine controller 302 is operatively connected to a cockpit 306 of the aircraft to receive any such commands or signals.

A timer 308 is started by the engine controller 302. The power coil 312A will remain energized until the timer 308 expires. In some embodiments, the timer 308 is started at the same time as the power coil 312 is energized. Alternatively, the timer 308 is started after the power coil 312A is energized. For example, the power coil 312A is energized in response to an engine shutdown request and the timer 308 is triggered in response to an aircraft shutdown request. In either case, the timer ensures that the engine controller 302 remains powered by the aircraft battery 304 sufficiently long to complete post engine shutdown functions.

In some embodiments, a bypass switch 310B is also provided in the electrical path between the engine controller 302 and the aircraft battery 304. A bypass coil 312B is adjacent to the bypass switch 310B and actuates the bypass switch 310B when energized. The bypass coil 312B and bypass switch 310B are used to bypass the timer-based method of power management for the engine controller 302, i.e. the delayed removal of aircraft battery power to the engine controller 302. An input in the cockpit 306 may be activated by the pilot to energize the bypass coil 312B, which pulls open the bypass switch 310B and cuts the aircraft battery power from the engine controller 302, regardless of any time remaining on the timer 308.

In some embodiments, the power coil 312A is used to maintain aircraft battery power to the engine controller 302 and a battery coil 312C is used to turn the aircraft battery on or off. The battery coil 312C may, for example, be energized upon receipt of an aircraft-on-ground confirmation or an engine shutdown request. This ensures that the power switch 310A stays closed for the duration of the timer. While the timer is going, the battery coil 312C may be de-energized, but the power switch 310A stays closed because the power coil 312A is still energized by the engine controller 302. When the timer 308 expires, the engine controller 302 de-energizes the power coil 312A, which causes the power switch 310A to latch open, thus opening the electrical path between the aircraft battery 304 and the engine controller 302 and removing the aircraft battery power from the engine controller 302. This ensures that the power coil 310A does not stay stuck in the closed position indefinitely.

FIG. 3B illustrates another example embodiment of the system 300 for managing power to the engine controller 302. In this example, the power coil 312A is energized by an aircraft-level component 314. The timer 308 is also started by the aircraft-level component 314, which can be any avionics software or hardware component that can be coupled, directly or indirectly, to the cockpit 306. When a predetermined trigger, such as a request to shut down the aircraft, is received by the aircraft-level component 314 from the cockpit 306, the power coil 312A is energized and ensures that power switch 310A remains closed. The timer 308 is started and when the timer 308 expires, the power coil 312A is de-energized by the aircraft-level component 314 and the power switch 310A is latched open, thus removing the aircraft battery power from the engine controller 302.

In some embodiments, the power coil 312A is energized at the same time as the timer 308 is started, in response to a predetermined trigger event such as a pilot-initiated request to shut down the aircraft. In some embodiments, the timer-based method of removing aircraft batter power from the engine controller 302 is bypassed using the bypass coil 312B and the bypass switch 310B.

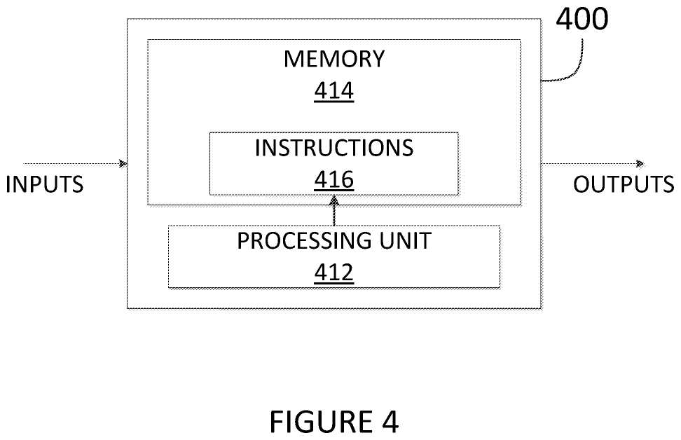

With reference to FIG. 4, the method 200 may be implemented by a computing device 410 as an embodiment of the engine controller 302 or the aircraft-level component 314 when implemented in software. The computing device 410 comprises a processing unit 412 and a memory 414 which has stored therein computer-executable instructions 416. The processing unit 412 may comprise any suitable devices configured to implement the functionality of the method 200 such that instructions 416, when executed by the computing device 410 or other programmable apparatus, may cause the functions/acts/steps performed by the engine controller 302 or the aircraft-level component 314 as described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, custom-designed analog and/or digital circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 516 executable by processing unit 412.

The methods and systems for managing power to an engine controller as described herein may be implemented in a high level procedural or object oriented programming or scripting language, or a combination thereof, to communicate with or assist in the operation of a computer system, for example the computing device 400. Alternatively, the methods and systems for managing power to an engine controller may be implemented in assembly or machine language. The language may be a compiled or interpreted language.

Embodiments of the methods and systems for managing power to an engine controller may also be considered to be implemented by way of a non-transitory computer-readable storage medium having a computer program stored thereon. The computer program may comprise computer-readable instructions which cause a computer, or more specifically the processing unit 412 of the computing device 400, to operate in a specific and predefined manner to perform the functions described herein, for example those described in the method 200.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the present disclosure. Still other modifications which fall within the scope of the present disclosure will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for managing power to an engine controller operatively coupled to an engine of an aircraft, the method comprising:
powering the engine controller from an aircraft battery;
starting a timer in response to a predetermined trigger to maintain the engine controller powered by the aircraft battery for a predetermined time; and
removing power from the aircraft battery to the engine controller when the timer expires.

2. The method of claim 1, wherein the predetermined trigger is one of an aircraft shutdown request and an engine shutdown request.

3. The method of claim 1, wherein the engine controller is powered from the aircraft battery in response to a confirmation that the aircraft has landed.

4. The method of claim 1, wherein powering the engine controller from the aircraft battery comprises energizing a power coil to close a power switch in an electrical path between the aircraft battery and the engine controller.

5. The method of claim 4, wherein the power coil is energized by the engine controller.

6. The method of claim 4, wherein the power coil is energized by an aircraft-level component.

7. The method of claim 1, wherein the timer is started by the engine controller upon receipt of the predetermined trigger.

8. The method of claim 1, wherein the timer is started by an aircraft-level component upon receipt of the predetermined trigger.

9. The method of claim 1, further comprising bypassing the timer and removing power from the aircraft battery to the engine controller in response to a bypass power-off request.

10. The method of claim 9, wherein bypassing the timer comprises energizing a bypass coil to open a bypass switch in an electrical path between the aircraft battery and the engine controller.

11. A system for managing power to an engine controller operatively coupled to an engine of an aircraft, the system comprising:
an engine controller;
an aircraft battery coupled to the engine controller via an electrical path;
a power switch in the electrical path;
a power coil adjacent to the power switch for actuating the power switch to close the electrical path and allow power to flow from the aircraft battery to the engine controller; and
a timer responsive to a predetermined trigger to maintain the power coil energized for a predetermined time.

12. The system of claim 11, wherein the predetermined trigger is one of a pilot-initiated aircraft shutdown request and a pilot-initiated engine shutdown request.

13. The system of claim 11, wherein the power coil is energized upon receipt of a confirmation that the aircraft has landed.

14. The system of claim 11, wherein the power coil is energized by the engine controller.

15. The system of claim 11, wherein the power coil is energized by an aircraft-level component.

16. The system of claim 11, wherein the timer is started by the engine controller upon receipt of the predetermined trigger.

17. The system of claim 11, wherein the timer is started by an aircraft-level component upon receipt of the predetermined trigger.

18. The system of claim 11, further comprising:
a bypass switch in the electrical path; and
a bypass coil adjacent to the bypass switch and responsive to a bypass power-off request.

19. The system of claim 18, wherein the bypass coil is energized by an input in a cockpit of the aircraft.
